(19) United States
(12) Patent Application Publication
(10) Pub. No.: US 2012/0205373 A1
(43) Pub. Date: Aug. 16, 2012

(54) Sound-dampening container

(76) Inventor: Mark A. Caldwell, Lookout Mountain, TN (US)

(21) Appl. No.: 13/370,089

(22) Filed: Feb. 9, 2012

Related U.S. Application Data
(60) Provisional application No. 61/442,236, filed on Feb. 12, 2011.

(51) Int. Cl. B65D 25/14; B05D 7/22; B65D 1/40

(52) U.S. Cl. 220/200; 206/524.6; 427/230

(57) ABSTRACT

There is provided a rigid container, comprising: a vessel having an inner surface; a cap having an underside; a first film substantially covering the inner surface of said vessel; and a second film on the underside of said cap, wherein said first and second coatings are substantially non-porous and have a Shore A durometer measurement of 10-90. There is also provided a method for making sound-dampened container, comprising: forming by blow molding a vessel having an inner surface comprising at least one polymer; coating the inner surface of said vessel form a film with a thickness of at least one silicone rubber; and curing said film at a temperature for a period of time to form a cured film with a Shore A durometer measurement of 10-90.

### PRIOR RELATED APPLICATIONS

This application claims priority to U.S. Ser. No. 61/442,236, filed Feb. 12, 2011, which is incorporated herein by reference in its entirety.

### FEDERALLY SPONSORED RESEARCH STATEMENT

Not applicable.

### FIELD OF THE INVENTION

The invention relates to a sound-dampening container, particularly to a bottle for a medicament, such as a pill or tablet.

### BACKGROUND OF THE INVENTION

Medicine comes in many forms, including hard tablets, pills, capsules, troches, lozenges, and pellets. Hard medicines make noise when shaken in their containers. This problem of noise is particularly acute when the medicament, such as cold medicine, antitussitive (cough medicine), antacid, acid reducer, fever reducer, analgesic (pain-killer), or sleep aid, is be accessed at night, a time when silence is important. As such, a rigid container which dampens the noise made by medicine when shaken is beneficial for those trying to get at the medicine when others near them are sleeping or trying to rest.

US20040149674 describes a pill bottle with a bag on the inside that prevents contact of the pills with the inner wall of the bottle, or walls lined with a “soft pliable spongy material”. The pills rest in the bag or strike the soft and pliable and spongy material when the bottle is moved, thus making the bottle quiet.

U.S. Pat. No. 6,770,342 describes a multilayer, quiet barrier composition comprising a silicone elastomer. Quiet, as used by U.S. Pat. No. '342, refers to the bag or container itself not making noise, not to the container preventing its contents from making noise.

JP2009046162 describes a silicone layer on a bottle.

What is lacking is a sound-dampened rigid container having a continuous film with a low hardness.

### SUMMARY OF THE INVENTION

This application provides a rigid container, such as a bottle or jar, which has a soft lining covering its entire inner surface. This soft lining reduces the noise made by the container's contents when they shaken against the inner walls of the container. Thus, the container is quiet, and is particularly useful for medicines used at night, when silence is desired. Furthermore, the soft lining reduces the frequency of breakage and the effects of friability of tablets and other medicaments when they strike the inner surface of the rigid container. This soft lining, or film, can comprise any material of suitable hardness or thickness to dampen the sound generated pills in the bottle, for example, silicone rubber with a Shore A durometer reading of 10-50 and a thickness of 0.5-3 mm.

Specifically, this application provides a rigid container, comprising: a vessel having an inner surface; a cap having an underside; and a first film substantially covering the inner surface of said vessel; and a second film on the underside of said cap, wherein said first and second coatings are substantially non-porous and have a Shore A durometer measurement of 10-90, for example 20-75. The first film can have a thickness of 0.1 mm to 10 mm, for example 0.5 mm to 3 mm. The first and second films can be the same or different. The thickness and hardness of the first and second films are such that sound is effectively dampened when an object impinges the inner surface of said vessel.

The vessel can be formed by blow molding, for example blow molding which comprises injection blow molding. The first film can comprise one or more selected from the group consisting of polyisoprene, polybutadiene, polychloroprene, butyl rubber, halogenated butyl rubber, styrene-butadiene rubber, nitrile rubber, hydrogenated nitrile rubber, ethylene propylene rubber, ethylene propylene diene rubber, epichlorohydrin rubber, polyacrylic rubber, polysiloxane, fluorosilicone rubber, fluoroelastomer, perfluoroelastomer, polyether block amides, chlorosulfonated polyethylene and ethylene-vinyl acetate. For example, the first film can comprise at least one polysiloxane, such as a silicone resin, silicone rubber, or combinations thereof.

In some embodiments, this application provides a rigid container, comprising a vessel having an inner surface; a cap having an underside; a first film substantially covering the inner surface of said vessel; and a second film on the underside of said cap, wherein said first film comprises at least one polysiloxane.

In other embodiments, this application provides a rigid container, comprising a vessel having an inner surface, wherein said vessel is formed by blow injection molding and comprises one or more selected from the group consisting of polyethylene (PE), polypropylene (PP), polyethylene terephthalate (PET), polyoxymethylene (POM), copolymers thereof, and combinations thereof; a cap having an underside; a first film substantially covering the inner surface of said vessel, wherein said first film is substantially non-porous and impermeable and comprises at least one polysiloxane; and a second film on the underside of said cap, wherein said first and second coatings have a Shore A durometer measurement of 10-90.

In yet other embodiments, this application provides a bottle, comprising: a vessel consisting essentially of silicone rubber having a Shore A durometer reading of 10-90; a cap having an underside; and a film on the underside of said cap having a Shore A durometer reading of 10-90.

In further embodiments, this application also provides a method for making sound-dampened container, comprising: forming by blow molding a vessel having an inner surface comprising at least one polymer; coating the inner surface of said vessel to form a film with a thickness of at least one silicone rubber; and curing said film at a temperature for a period of time to form a cured film with a Shore A durometer measurement of 10-90. The coating can be performed using one or more selected from the group consisting of spin coating, soaking, vacuum deposition, or spray coating. The temperature can be 30° C. to 300° C., for example 100° C. to 200° C. The period of time can be 1 minute to 10 hours, for example 1 hour to 3 hours.

### DESCRIPTION OF EMBODIMENTS OF THE INVENTION

The following abbreviations are used herein:

| | |
|---|---|
| ABS | acrylonitrile butadiene styrene |
| BIIR | chloro isobutylene isoprene rubber |
| BR | butadiene rubber |
| CIIR | chloro isobutylene isoprene rubber |
| CR | chloroprene rubber |
| EBM | extrusion blow molding |
| ECO | epichlorohydrin rubber |
| EPDM | ethylene propylene diene rubber |
| EPM | ethylene propylene rubber |
| EVA | ethylene vinyl acetate |
| HDPE | high-density polyethylene |
| HNBR | hydrogenated nitrile rubber |
| IBM | injection blow molding |
| IIR | isobutylene isoprene rubber |
| IR | isoprene rubber |
| LDPE | low-density polyethylene |
| LLPE | linear low density polyethylene |
| NBR | nitrile butadiene |
| NR | natural rubber |
| PA | polyamide |
| PAA | polyacrylic acid |
| PB | polybutylene |
| PBT | polybutylene terephthalate |
| PC | polycarbonate |
| PE | polyester |
| PE | polyethylene |
| PEBA | polyether block amides |
| PES | polysulfone |
| PET, PETE | polyethylene terephthalate |
| PEX, XLPE | crosslinked polyethylene |
| PI | polyimide |
| PLA | polylactic acid |
| PMMA | poly(methyl methacrylate) |
| POM | polyoxymethylene |
| PP | polypropylene |
| PPE | polyphenyl ether |
| PS | polystyrene |
| psi | pounds per square inch |
| PTFE | polytetrafluoroethylene |
| PU | polyurethane |
| PVC | polyvinyl chloride |
| PVDC | polyvinylidine chloride |
| SAN | styrene-acrylonitrile |
| SBM | stretch blow molding |
| SBR | styrene-butadiene rubber |
| SMA | styrene maleic anhydride |
| UV | ultraviolet |

“Container” refers to an object which can contain other smaller objects, gases and/or liquids. “Rigid container” refers to a stiff container which does not easily yield to pressure under normal use, not pliant or flexible, and is generally hard. Examples of rigid containers include, but are not limited to, beakers, bins, bottles, bowels, boxes, buckets, cans, canisters, canteens, capsules, carafes, cartons, casks, caskets, flasks, jars, jugs, packages, pods and pots. Of particular interest are jars and bottles, especially bottles. In contrast, a non-rigid or flexible container, such as a bag or pouch, is designed so that it can easily deform or bend under normal use.

The containers described herein are sound dampening; that is, when a rigid medicine is shaken in the container, the noise of its impingement on the container's inner surface is diminished, dulled, deadened, suppressed or otherwise reduced. Preferably, the sound is reduced completely, and the container is quiet or silent when contents are shaken. That is, no noise or sound is made, especially no disturbing sound, when someone removes pills or tablets from the bottle.

“Vessel”, as used herein, refers to the part of a rigid container that receives and stores objects until use. The vessel is shaped so that it can be closed with a lid, cap, and/or seal.

“Bottle” refers to a rigid container having a body, mouth and neck,

wherein the neck is narrower than the body and its mouth. Bottles can be made of, for example, glass, clay, polymers, metal such as aluminum, or other rigid and impervious materials. Examples of polymers suitable for making bottles include, but are not limited to polyacrylic acid (PAA), crosslinked polyethylene (PEX or XLPE), polyethylene (PE), polyethylene terephthalate (PET or PETE), polyphenyl ether (PPE), polyvinyl chloride (PVC), polyvinylidine chloride (PVDC), polylactic acid (PLA), polypropylene (PP), polybutylene (PB), polybutylene terephthalate (PBT), polyamide (PA), polyimide (PI), polycarbonate (PC), polytetrafluoroethylene (PTFE), polystyrene (PS), polyurethane (PU), polyester (PE), acrylonitrile butadiene styrene (ABS), poly(methyl methacrylate) (PMMA), polyoxymethylene (POM), polysulfone (PES), styrene-acrylonitrile (SAN), ethylene vinyl acetate (EVA), styrene maleic anhydride (SMA), and the like, and combinations thereof, and copolymers thereof. In particular, bottles can comprise a polymer selected from the group consisting of polyethylene (PE), polyethylene terephthalate (PET or PETE), polyvinyl chloride (PVC), polypropylene (PP), polycarbonate (PC), polytetrafluoroethylene (PTFE), polystyrene (PS), polyester (PE), polyoxymethylene (POM), copolymers thereof, and combinations thereof. Polyethylene can be selected from low-density polyethylene (LDPE), linear low-density polyethylene (LLPE) or high-density polyethylene (HDPE).

Bottles can be formed by blow molding, also known as blow forming, such as by extrusion blow molding, injection blow molding, or stretch blow molding. In blow forming, polymer is melted and formed it into a perform or parison, a tube-like form with a hole in one end through which compressed air can enter. When the parison is clamped into a mold, air is pumped in to expand the parison to match the mold. Once the polymer cools and hardens, the mold opens up and the bottle is ejected.

In extrusion blow molding (EBM), polymer is melted and extruded into a parison, which is then captured by closing it into a cooled metal mold. Air is blown into the parison, inflating it into the shape of the hollow container, such as a bottle. After the polymer has cooled sufficiently, the mold is opened and the bottle is ejected. EBM can be continuous or intermittent. In continuous EBM, the parison is extruded continuously and the individual parts are cut off by a suitable knife. In intermittent EBM, the parison is extruded intermittently, and individual parts are cut off when extrusion stops. Straight EBM is similar to injection molding, whereby a screw turns, then stops and pushes out the melted polymer. In the accumulator method, an accumulator gathers melted polymer and, when the previous mold has cooled and enough polymer has accumulated, a rod pushes the melted polymer to form a parison.

Injection blow molding (IBM) can produce of hollow objects in large quantities. IBM is divided into three steps: injection, blowing and ejection. The IBM machine uses an extruder barrel and screw assembly, which melts the polymer. Molten polymer is fed into a manifold where it is injected through nozzles into a hollow, heated preform mold. The preform mold forms the external shape and is clamped around a mandrel (a core rod), which forms the internal shape of the preform. The preform consists of a fully formed bottle or jar neck with a thick tube of polymer attached, which will form the body. The preform mold opens and the core rod is rotated and clamped into the hollow, chilled blow mold. The core rod opens and allows compressed air into the preform, which inflates it to the finished article shape. After a cooling period the blow mold opens and the core rod is rotated to the ejection position. The finished article is stripped off the core rod and leak-tested before packing. The preform and blow mold can have many cavities, typically 3 to 16 depending on the article size and the required output.

In stretch blow molding (SBM), polymer is molded into a preform using injection molding. The preform is produced with a bottleneck, including threads (the “finish”) on one end. The preform is cooled, packaged, reheated above its glass transition temperature, typically using infrared heaters, and is blown into bottles using high-pressure air and metal blow molds. Usually the preform is stretched with a core rod as part of the process. In the single-stage process both preform manufacture and bottle blowing are performed in the same machine. Stretching some polymers, such as polyethylene terephthalate (PET), strain hardens the polymer, allowing the bottles to resist deformation under pressure the up to about 60 pounds per square inch (psi).

“Film” refers to a thin layer, coating, skin or membrane, particularly to a layer or coating applied and substantially adhering to the inner surface of a vessel or container. In particular, the films of this invention have a hardness such that sound produced by objects in the container is reduced. Preferably, the film is elastic or consists essentially of an elastomer, a polymer having high viscoelasticity, a low Young's modulus and a high yield strain, as compared with other materials. The monomers comprising the polymer are usually made of carbon, hydrogen, oxygen and/or silicon. Elastomers are amorphous polymers existing above their glass transition temperature, so considerable segmental motion is possible and, at ambient temperature, they are relatively soft and deformable.

Elastomers can be unsaturated rubbers that can be cured, for example, by sulfur vulcanization, or saturated rubbers, which cannot be cured by vulcanization. Examples of unsaturated rubbers include, but are not limited to, natural isoprene, such as cis-1,4-polyisoprene natural rubber (NR) and trans-1,4-polyisoprene gutta-percha; synthetic polyisoprene, also called isoprene rubber (IR); polybutadiene, also called butadiene rubber (BR); chloroprene rubber (CR), such as polychloroprene, Neoprene™ and Baypren™; butyl rubber, a copolymer of isobutylene and isoprene (IIR); halogenated butyl rubber, such as chlorobutyl rubber (CIIR) and bromobutyl rubber (BIIR); styrene-butadiene rubber, a copolymer of styrene and butadiene (SBR); nitrile rubber, a copolymer of butadiene and acrylonitrile (NBR); hydrogenated nitrile rubber (HNBR), such as Therban™ and Zetpol™. Examples of saturated rubbers include, but are not limited to, ethylene propylene rubber (EPM), a copolymer of ethylene and propylene; ethylene propylene diene rubber (EPDM), a terpolymer of ethylene, propylene and a diene-component; epichlorohydrin rubber (ECO), polyacrylic rubber, silicone rubber, fluorosilicone rubber, fluoroelastomers, such as Viton™, Tecnoflon™, Fluorel™, Aflas™ and Dai-El™; perfluoroelastomers, such as Tecnoflon™ PFR, Kalrez™, Chemraz™ and Perlast™; polyether block amides (PEBA), chlorosulfonated polyethylene (CSM), such as Hypalon™; and ethylene-vinyl acetate (EVA).

Of particular interest are polysiloxanes such as silicone resin and silicone rubber, which are widely used in industry and come in multiple formulations. Polysiloxane has a backbone consisting essentially of Si—O—Si units rather than carbon-carbon bond. This backbone, among other things, permits an extremely low glass transition temperature of about −127° C. Polysiloxane is very flexible due to large bond angles and bond lengths when compared to those found in polyethylene. Polysiloxane also tends to be chemically inert, due to the strength of the silicon-oxygen bond. The silicon-oxygen bond in polysiloxane is significantly more stable than the carbon-oxygen bond in polyoxymethylene (POM, a structurally similar polymer) due to its higher bond energy.

“Silicone resin” refers to a type of polysiloxane comprising branched, cage-like oligosiloxanes with the general formula of RₙSiXₘO_{y}, wherein each R is a non-reactive substituent, such as an alkyl group, for example methyl, or an aromatic group, for example, phenyl; and X is H, OH, Cl or OR. These groups are reacted together (condensed) to give highly cross-linked, insoluble polysiloxane networks. When R is methyl, the four possible functional siloxane monomeric units are described as follows:

“M” stands for Me₃SiO,

“D” for Me₂SiO₂,

“T” for MeSiO₃, and

“Q” for SiO₄. (Note that a network of only Q groups becomes fused quartz.)

The most abundant silicone resins are built of D and T units, and are called “DT resins”. The other most common silicone resins are built from M and Q units (MQ resins); however, many other combinations (MDT, MTQ, QDT) are also used. Materials of molecular weight in the range of 1000-10000 g/mol (1-10 kg/mol) are useful in pressure sensitive adhesives, silicone rubbers, coatings and additives. Silicone resins are typically prepared by hydrolytic condensation of various silicone precursors.

“Silicone rubber” refers to a silicone-based rubber-like material. Silicone rubber is often a one-part or two-part polymer, and may contain fillers to improve properties or reduce cost. Silicone rubber is generally non-reactive, stable, and resistant to extreme environments and temperatures from −55° C. to 300° C. while still maintaining its properties. At the extreme temperatures, tensile strength, elongation, tear strength and compression set can be far superior to conventional rubbers. Organic rubber has a carbon backbone which can leave it susceptible to ozone, ultraviolet (UV), heat and other ageing factors that silicone rubber can withstand. Because of these properties and its ease of manufacturing and shaping, silicone rubber can be found in a wide variety of products. Typical properties of a silicone rubber are shown in Table 1.

TABLE 1
Typical properties of a silicone rubber

| Hardness, shore A | 10-90 | |
|---|---|---|
| Tensile strength | 11 | N/mm² |
| Elongation at break | 100-1100% | |
| Maximum temperature | 300 | ° C. |
| Minimum temperature | −120 | ° C. |

During manufacture heat can be used to vulcanize, set or cure the silicone into its rubber-like or elastic form. This curing process is normally carried out in two stages: first when the silicone rubber is shaped, and again in a prolonged post-cure process. Silicone rubber can also be injection molded. In some embodiments, the sound-dampening bottle of this invention consists essentially of a silicone resin and/or silicone rubber.

Thickness of the film can be 1 mm to 25 mm, for example 10 mm to 20 mm, 1 mm to 5 mm, or 2 to 4 mm.

“Hardness” refers to how resistant solid matter is a permanent shape change caused by applied force. Macroscopic hardness is generally characterized by strong intermolecular bonds. However, the behavior of solid materials under force is complex; thus, different measurements of hardness have been developed: scratch hardness, indentation hardness, and rebound hardness. Hardness is dependent on ductility, elasticity, polymerity, strain, strength, toughness, viscoelasticity, and viscosity or the material. Each class of measurement has several individual measurement scales. For practical reasons, conversion tables are used to convert between one scale and another.

Scratch hardness measures how resistant a sample is to fracture or permanent plastic deformation due to friction from a sharp object. The principle is that an object made of a hard material will scratch an object made of a softer material. The most common test is Mohs scale used in mineralogy. A sclerometer can be used to make this measurement. Rebound hardness, also known as dynamic hardness, measures the height of the bounce of a diamond-tipped hammer dropped from a fixed height onto a material. This type of hardness relates to elasticity. A sceroscope can be used to measure rebound hardness. Two scales that measure rebound hardness are the Leeb and the Bennett hardness scales.

Indentation hardness measures the resistance of a sample to permanent plastic deformation due to a constant compression load from a sharp object; they are primarily used in engineering and metallurgy fields. The tests work on the basic premise of measuring the critical dimensions of an indentation left by a specifically dimensioned and loaded indenter. Common indentation hardness scales are Shore, Rockwell, Vickers, and Brinell, and can be measured using a durometer.

Durometer can refer to the measurement, as well as the instrument itself. The two most common Shore scales for durometer measurements, are the ASTM D2240 type A and type D scales. The A scale is for softer polymers, whereas the D scale is for harder ones. However, the ASTM D2240-00 testing standard calls for a total of 12 scales, depending on the intended use: types A, B, C, D, DO, E, M, O, OO, OOO, OOO-S, and R. Each scale results in a value between 0 and 100, with higher values indicating a harder material. The durometer scale of interest herein is the Shore A durometer scale.

Durometer measures the depth of an indentation in the material created by a given force on a standardized presser, or indenting, foot. This depth depends on the material's hardness, viscoelasticity, shape of the presser foot, and test duration. ASTM D2240 durometers allow measurement of initial hardness, or the indentation hardness after a given period of time. The basic test requires applying a constant force without shock, and measuring the hardness (depth of the indentation). If a timed hardness is desired, force is applied for the required time and then read. The tested material is at least 6.4 mm (0.25 inch) thick. The measurement is dimensionless, partly because no simple relationship exists between a material's durometer reading in one scale, and its durometer reading in any other scale, or by any other hardness test. Examples of durometer measurements of various common materials is shown in Table 2.

TABLE 2
Durometer measurements of various common materials

| Material | Durometer | Scale |
|---|---|---|
| Bicycle gel seat | 15-30 | OO |
| Chewing gum | 20 | OO |
| Rubber band | 25 | A |
| Door seal | 55 | A |
| Automotive tire tread | 70 | A |
| Soft skateboard wheel | 75 | A |
| Hydraulic O-ring | 70-90 | A |
| Hard skateboard wheel | 98 | A |
| Ebonite Rubber | 100 | A |
| Solid truck tires | 50 | D |
| Hard hat | 75 | D |

The first film on the inner surface of the vessel or second film on the underside of the cap can have a Shore A durometer of 10-90, such as 10-50, 20-75, 20-80, or 20-30. The Shore A durometer reading for the first film and the second film can be the same or different.

The film can be applied to the sound-dampening container by any method in the art, for example spin coating, soaking, vacuum deposition, or spray coating. In spin coating, a suitable polymer or polymer precursor is placed in the vessel of a rigid container and the container is spun to distribute the polymer or polymer precursor evenly on the inner surface of the vessel. In soaking, the vessel is filled with a solution of a suitable polymer or polymer precursor, and the solution is allowed to remain in contact with the inner surface of the vessel until a continuous film of suitable thickness and hardness is formed on the inner surface of the vessel. In vacuum deposition, the suitable polymer or polymer precursor is introduced in the vapor phase under vacuum. In spray coating, a solution of the suitable polymer or polymer precursor is sprayed on the other inner surface of the vessel. In each method, the process is operated for a time sufficient to substantially coat the inner surface of the vessel with the suitable polymer or polymer precursor having a suitable thickness. Then, the coating can be cured to obtain a film of suitable hardness for the rigid container to be sound-dampening. Alternatively, a silicone rubber liner can be blow injection molded and then adhered to the inner surface of the rigid container.

The present invention is exemplified with respect to sound-dampening bottles for use with hard medicine. However, this container is exemplary only, and the invention can be broadly applied to any rigid container where sound dampening would be beneficial. The following examples are intended to be illustrative only, and not unduly limit the scope of the appended claims.

### Example 1

### Bottles

Bottles having a 100-mL vessel are formed from polyethylene (PE) and polyethylene terephthalate (PET or PETE). The inner surface of the vessel and the underside of the caps are coated with silicone rubber or nitrile rubber. Alternatively, bottles are formed from silicone rubber having a hardness suitable to be sound-dampening when a hard medicine impinges on the inner surface of the vessel. The inner surface of each bottle is tested using the Shore A durometer measurement of Example 2. Average film thickness is measured using calipers at several points on the bottle and subtracting the wall thickness of the uncoated vessel at each point. Different film thicknesses and compositions are tested.

### Example 2

### Films and Film Hardness

The Shore A durometer measurement is taken using an indenting foot comprising a hardened steel rod with 1.1-1.4 mm diameter, and a truncated 35° cone. The applied mass is 0.82 kg and resulting force is 8.06 N. The final value of the hardness depends on the depth of the indenter after it is applied for 15 seconds on the film. If the indenter penetrates 2.54 mm (0.100 inch) or more into the material, the durometer is 0 for the Shore A scale. If it does not penetrate at all, then the durometer is 100 for the Shore A scale.

### Example 3

### Sound Measurement

Quietness or absence of noise is evaluated by a noise emission test. The bottles of Example 1 are filled with 100 beads the size of tablets. The bottles are shaken by a shaker at a rate of about 1.5 Hz. The noise generated by the bottle is measured in an anechoic room with a microphone positioned at 150 mm from the middle of the bottle. The tests are run at a temperature of about 22° C. and a relative humidity of about 50%. Five bottles are tested for each film hardness/composition and 5 measurements are made for each bottle. The measurements performed are the equivalent continuous sound pressure level (Leq), frequency weighing A, and the Sound Pressure Level with Impulse average time, frequency weighing A.

The use of the word “a” or “an” when used in conjunction with the term “comprising” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim.

The following references are incorporated by reference in their entirety:

US20040149674.

U.S. Pat. No. 6,770,342.

JP2009046162.

What is claimed is:

1. A rigid container, comprising:
a) a vessel having an inner surface;
b) a cap having an underside;
c) a first film substantially covering the inner surface of said vessel; and
d) a second film on the underside of said cap,
wherein said first and second coatings are substantially non-porous and each has a Shore A durometer measurement of 10-90.

2. The container of claim 1, wherein said Shore A durometer measurement is 20-75.

3. The container of claim 1, wherein said first film has a thickness of 0.1 mm to 10 mm, and said second film has a thickness of 0.1 mm to 10 mm.

4. The container of claim 3, wherein said first film has a thickness of 0.5 mm to 3 mm, and said second film has a thickness of 0.5 mm to 3 mm.

5. The container of claim 1, wherein the thickness and hardness of the first and second films are such that sound is effectively dampened when an object impinges the inner surface of said vessel.

6. The container of claim 1, wherein said vessel comprises a polymer.

7. The container of claim 6, wherein said polymer is selected from the group consisting of polyacrylic acid (PAA), crosslinked polyethylene (PEX or XLPE), polyethylene (PE), polyethylene terephthalate (PET or PETE), polyphenyl ether (PPE), polyvinyl chloride (PVC), polyvinylidine chloride (PVDC), polylactic acid (PLA), polypropylene (PP), polybutylene (PB), polybutylene terephthalate (PBT), polyamide (PA), polyimide (PI), polycarbonate (PC), polytetrifluoroethylene (PTFE), polystyrene (PS), polyurethane (PU), polyester (PE), acrylonitrile butadiene styrene (ABS), poly(methyl methacrylate) (PMMA), polyoxymethylene (POM), polysulfone (PES), styrene-acrylonitrile (SAN), ethylene vinyl acetate (EVA), and styrene maleic anhydride (SMA), and copolymers thereof, and combinations thereof.

8. The container of claim 1, wherein said vessel is formed by blow molding.

9. The container of claim 1, wherein said first film comprises one or more selected from the group consisting of polyisoprene, polybutadiene, polychloroprene, butyl rubber, halogenated butyl rubber, styrene-butadiene rubber, nitrile rubber, hydrogenated nitrile rubber, ethylene propylene rubber, ethylene propylene diene rubber, epichlorohydrin rubber, polyacrylic rubber, polysiloxane, fluorosilicone rubber, fluoroelastomer, perfluoroelastomer, polyether block amides, chlorosulfonated polyethylene, and ethylene-vinyl acetate.

10. The container of claim 9, wherein said first film comprises at least one polysiloxane.

11. The container of claim 10, wherein said polysiloxane is silicone resin, silicone rubber, or combinations thereof.

12. A rigid container, comprising:
a) a vessel having an inner surface;
b) a cap having an underside;
c) a first film substantially covering the inner surface of said vessel; and
d) a second film on the underside of said cap,
wherein said first film comprises at least one polysiloxane.

13. The container of claim 12, wherein said first film has a Shore A durometer reading of 10-90.

14. The container of claim 12, wherein said first film has a thickness of 0.1 mm to 10 mm, and said second film has a thickness of 0.1 mm to 10 mm.

15. The container of claim 12, wherein the thickness and hardness of the first and second films are such that sound is effectively dampened when an object impinges the inner surface of said vessel.

16. The container of claim 12, wherein said vessel comprises a polymer.

17. The container of claim 16, wherein said polymer is selected from the group consisting of polyacrylic acid (PAA), crosslinked polyethylene (PEX or XLPE), polyethylene (PE), polyethylene terephthalate (PET or PETE), polyphenyl ether (PPE), polyvinyl chloride (PVC), polyvinylidine chloride (PVDC), polylactic acid (PLA), polypropylene (PP), polybutylene (PB), polybutylene terephthalate (PBT), polyamide (PA), polyimide (PI), polycarbonate (PC), polytetrifluoroethylene (PTFE), polystyrene (PS), polyurethane (PU), polyester (PE), acrylonitrile butadiene styrene (ABS), poly(methyl methacrylate) (PMMA), polyoxymethylene (POM), polysulfone (PES), styrene-acrylonitrile (SAN), ethylene vinyl acetate (EVA), styrene maleic anhydride (SMA), and copolymers thereof, and combinations thereof.

18. The container of claim 17, wherein said vessel is formed by blow molding.

19. The container of claim 15, wherein said polysiloxane is silicone resin, silicone rubber, or combinations thereof.

20. A method for making sound-dampened container, comprising:
a) forming by blow molding a vessel having an inner surface comprising at least one polymer;
b) coating the inner surface of said vessel form a film with a thickness of at least one silicone rubber; and
c) curing said film at a temperature for a period of time to form a cured film with a Shore A durometer measurement of 10-90.
